(19) United States
(12) Patent Application Publication
(10) Pub. No.: US 2009/0033565 A1
(43) Pub. Date: Feb. 5, 2009

(54) ANTENNA STRUCTURE AND WIRELESS COMMUNICATION APPARATUS THEREOF

(76) Inventors: Li-Jean Yen, Taipei Hsien (TW); Chih-Ming Wang, Taipei Hsien (TW); Hen-An Chen, Taipei Hsien (TW); Bing-Chun Chung, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/874,215

(22) Filed: Oct. 18, 2007

(30) Foreign Application Priority Data
Jul. 31, 2007 (TW) 096128110

(51) Int. Cl. H01Q 9/04; H01Q 1/24; H01Q 1/38

(52) U.S. Cl. 343/702; 343/700 MS

(57) ABSTRACT

An antenna structure includes a conductive film, a radiation element, and a feeding point. The radiation element includes a first radiation object and a second radiation object. The second radiation object has a first radiation arm, a second radiation arm, and a third radiation arm. The first radiation arm is coupled to the first radiation object, and the second radiation arm is extended from the first radiation arm to be coupled to the third radiation arm, wherein there is a first angle included between the first radiation arm and the second radiation arm, and there is a second angle included between the second radiation arm and the third radiation arm. The feeding point is coupled between the conductive film and the radiation element.

### BACKGROUND OF THE INVENTION

1. Field of the Invention

The present invention relates to an antenna structure and related wireless communication apparatus, and more particularly, to an extendable antenna structure and related wireless communication apparatus.

2. Description of the Prior Art

As wireless telecommunication develops with the trend of micro-sized mobile communication products, the location and the space arranged for antennas are limited. Therefore, some built-in micro antennas have been developed. Currently, some micro antennas such as a chip antenna, a planar antenna and so on are commonly used. All these antennas have the feature of occupying small volume.

Due to the planar antenna having advantages such as small size, light weight, ease of manufacturing, low cost, high reliability, and can be attached to surfaces of any object. Therefore, the micro-strip antenna and printed antenna are widely used in wireless communication systems. For example, dual-band monopole antennas or dual-band dipole antennas are suited for use in 3G transceivers. The operational frequency bands for 3G communications include 850 MHz, 900 MHz, 1800 MHz, and 1900 MHz for the global system for mobile communication (GSM), 824-894 MHz for the advanced mobile phone system (AMPS), 1710-1880 MHz for the digital communication system (DCS), 2100 MHz for the universal mobile telecommunications system (UMTS), and 1570-1580 MHz for the global positioning system (GPS).

Thus a variety of reformed antennas and wireless communication products appear for various market requirements. How to reduce sizes of the antennas, improve antenna efficiency, and improve impedance matching becomes an important topic of the field.

### SUMMARY OF THE INVENTION

It is one of the objectives of the present invention to provide an extendable antenna structure and related wireless communication apparatus to solve the abovementioned problems.

The present invention discloses an antenna structure. The antenna structure includes a conductive film, a radiation element, and a feeding point. The radiation element includes a first radiation object and a second radiation object. The second radiation object includes a first radiation arm, a second radiation arm, and a third radiation arm. The second radiation arm is extended from the first radiation arm to be coupled to the third radiation arm, whereof there is a first angle included between the first radiation arm and the second radiation arm, and there is a second angle included between the second radiation arm and the third radiation arm. The feeding point is coupled between the conductive film and the radiation element.

In one embodiment, an area of the conductive film is greater than a predetermined area. Therefore, the first radiation object and the conductive film form a monopole antenna, and the second radiation object and the conductive film form another monopole antenna.

In one embodiment, an area of the conductive film is smaller than a predetermined area. Therefore, the first radiation object and the conductive film form a monopole antenna, and the second radiation object and the conductive film form a dipole-like antenna.

The present invention further discloses a wireless communication apparatus. The wireless communication apparatus includes a housing and an extendable antenna. The housing is formed with a conductive material. The extendable antenna is located inside the housing when the extendable antenna is in a closed position, and the extendable antenna is exposed to the housing when the extendable antenna is in an operated position. The extendable antenna includes a radiation element and a feeding point. The radiation element includes a first radiation object and a second radiation object. The second radiation object includes a first radiation arm, a second radiation arm, and a third radiation arm. The first radiation arm is coupled to the first radiation object, and the second radiation arm is extended from the first radiation arm to be coupled to the third radiation arm, whereof there is a first angle included between the first radiation arm and the second radiation arm, and there is a second angle included between the second radiation arm and the third radiation arm.

In one embodiment, the wireless communication apparatus includes a sliding mechanism and a contact switch. The sliding mechanism is used for carrying the extendable antenna and guiding the extendable antenna sliding to the closed position or the operated position. The contact switch is used for contacting the housing to make the extendable antenna electrically connect to the housing when the extendable antenna is in the operated position.

In one embodiment, the wireless communication apparatus includes a rotating mechanism. The rotating mechanism is coupled to the extendable antenna in a rotatable manner for guiding the extendable antenna rotating to the closed position or the operated position. The rotating mechanism contacts the housing to make the extendable antenna electrically connect to the housing when the extendable antenna is in the operated position.

In one embodiment, when the extendable antenna is in the operated position, the first radiation object and a first plane of the housing form a monopole antenna, and the second radiation object and the first plane form another monopole antenna.

In one embodiment, when the extendable antenna is in the operated position, the first radiation object and a first plane of the housing form a monopole antenna, and the second radiation object and a second plane of the housing form an dipole-like antenna.

The present invention further discloses a wireless communication apparatus. The wireless communication apparatus includes a housing and an extendable antenna. The housing is formed with a conductive material. The extendable antenna is exposed to the housing and coupled to the housing when the extendable antenna is in an operated position. The extendable antenna includes a radiation element and a feeding point. The radiation element includes a first radiation object and a second radiation object. The second radiation object includes a first radiation arm, a second radiation arm, and a third radiation arm. The first radiation arm is coupled to the first radiation object, and the second radiation arm is extended from the first radiation arm to be coupled to the third radiation arm.

In one embodiment, the housing includes a first plane and a second plane, and an opening is disposed between the first plane and the second plane. When the extendable antenna is in the operated position, the first radiation object and the first plane form a monopole antenna, and the second radiation object and the second plane form a dipole-like antenna.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an antenna structure according to an embodiment of the present invention.

FIG. 2 is a diagram illustrating the VSWR of the antenna structure in FIG. 1.

FIG. 3 is a diagram of an antenna structure according to another embodiment of the present invention.

FIG. 4 is a diagram of an antenna structure according to another embodiment of the present invention.

FIG. 5 is a diagram of an antenna structure according to another embodiment of the present invention.

FIG. 6 is a diagram of a wireless communication apparatus according to an embodiment of the present invention.

FIG. 7 is a diagram showing an exemplary embodiment of the extendable antenna and the sliding mechanism in FIG. 6.

FIG. 8 is a diagram of a wireless communication apparatus according to another embodiment of the present invention.

FIG. 9 is a diagram illustrating the VSWR of the wireless communication apparatus in FIG. 6.

FIG. 10 is a diagram of an antenna structure according to another embodiment of the present invention.

FIG. 11 is a diagram illustrating the VSWR of the antenna structure in FIG. 10.

FIG. 12 is a diagram of an antenna structure according to another embodiment of the present invention.

FIG. 13 is a diagram of an antenna structure according to another embodiment of the present invention.

FIG. 14 is a diagram of an antenna structure according to another embodiment of the present invention.

FIG. 15 is a diagram of a wireless communication apparatus according to another embodiment of the present invention.

FIG. 16 is a diagram of a wireless communication apparatus according to another embodiment of the present invention.

FIG. 17 is a diagram illustrating the VSWR of the wireless communication apparatus in FIG. 15.

FIG. 18 is a diagram of a radiation pattern of the wireless communication apparatus in FIG. 15.

FIG. 19 is a diagram of an antenna gain table of the wireless communication apparatus in FIG. 15.

### DETAILED DESCRIPTION

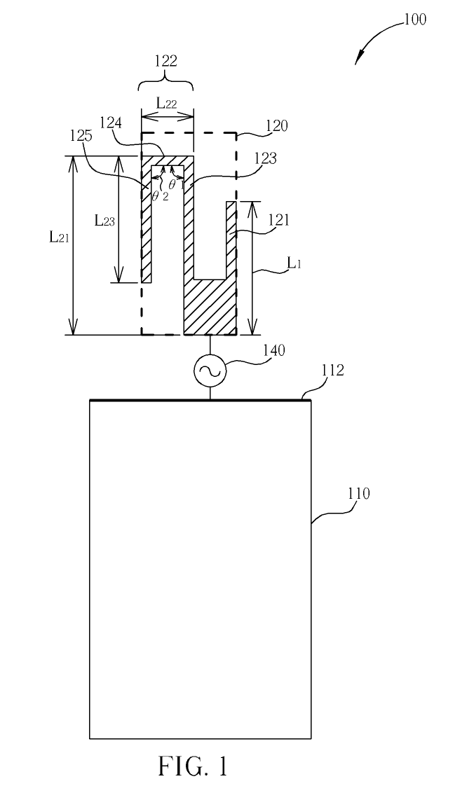

Please refer to FIG. 1. FIG. 1 is a diagram of an antenna structure 100 according to an embodiment of the present invention. As shown in FIG. 1, the antenna structure 100 includes a conductive film 110, a radiation element 120, and a feeding point 140. The conductive film 110 includes a first side 112, and the radiation element 120 is disposed in one side of the first side 112. The radiation element 120 includes a first radiation object 121 and a second radiation object 122, whereof the first object 121 is approximately perpendicular to the first side 112 of the conductive film 110. The second radiation object 122 includes a first radiation arm 123, a second radiation arm 124, and a third radiation arm 125. The first radiation arm 123 is coupled to the first radiation object 121 and is approximately perpendicular to the first side 112 of the conductive film 110, and the second radiation arm 124 is extended from the first radiation arm 123 to be coupled to the third radiation arm 125, whereof there is a first angle θ1 included between the first radiation arm 123 and the second radiation arm 124, and there is a second angle θ2 included between the second radiation arm 124 and the third radiation arm 125. In one embodiment, both of the angles are 90 degrees. The first radiation object 121 and the second radiation object 122 are located in the same plane. The feeding point 140 is coupled between the conductive film 110 and the radiation element 120.

In this embodiment, an area of the conductive film 110 is designed to be greater than a predetermined area. Therefore, the conductive film 110 is viewed as a grounding plane. At this time, the first radiation object 121 and the conductive film 110 form a monopole antenna, and the second radiation object 122 and the conductive film 110 form another monopole antenna. Please keep referring to FIG. 1. The antenna structure 100 is an antenna with dual-band resonance mode characteristics, whereof the first radiation object 121 is used for resonating at a higher operating frequency and has a length L₁ approximately equaling one-fourth of a wavelength (λ/4) of a first resonance mode generated by the antenna structure 100. The first radiation arm 123, the second radiation arm 124, the third radiation ram 125 of the second radiation object 122 are together used for resonating at a lower operating frequency and have a sum of their lengths (L₂₁+L₂₂+L₂₃) approximately equaling one-fourth of a wavelength of a second resonance mode generated by the antenna structure 100. Furthermore, the lengths of the first radiation arm 123, the second radiation arm 124, and the third radiation arm 125 are not fixed, and can be adjusted according to user demands. For example, the length L₂₁ of the first radiation arm 123 can be adjusted to one-fourth of a wavelength of a third resonance mode generated by the antenna structure 100. Therefore, an antenna with three-band resonance mode characteristics can be made through adjusting the length L₂₁ of the first radiation arm 123.

In one embodiment, the first resonance mode generated by the antenna structure 100 can be universal mobile telecommunications system (UMTS), GSM 1800, or GSM 1900, which has an operating frequency band of 1920-2170 MHz, 1710-1880 MHz, and 1850-1990 MHz, respectively. The second resonance mode generated by the antenna structure 100 can be GSM 900 or GSM 850, which has an operating frequency band of 880-960 MHz and 824-894 MHz, respectively. The third resonance mode generated by the antenna structure 100 can be global positioning system (GPS), which has an operating frequency band of 1570-1580 MHz. However, the abovementioned resonance modes generated by the antenna structure 100 are merely examples and are not limited to them only. Other resonance modes in other wireless communication standards are also suitable by proper designs.

Please note that, the first angle θ1 included between the first radiation arm 123 and the second radiation arm 124 and the second angle θ2 included between the second radiation arm 124 and the third radiation arm 125 are not limited only to right angles, and can be smaller or greater than 90 degrees. That is, the degrees of the angles should not limitations of the present invention. Thus, the radiation element 120 presents an S-type. In one embodiment, the conductive film 110 is constructed by metal material, such as Al—Mg alloy, but is not limited to this only. Namely, a conductive film constructed by any conductive material also belongs to the scope of the present invention.

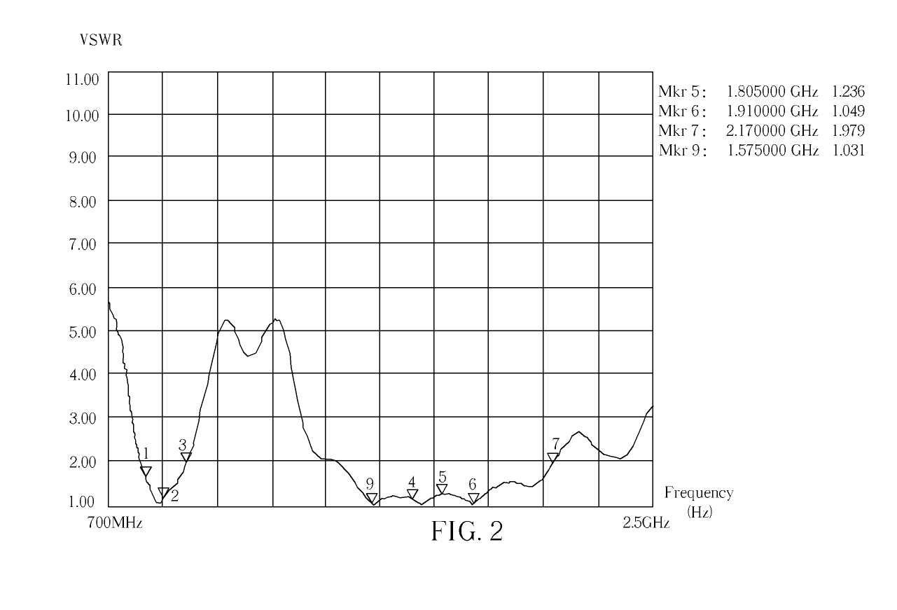

Please refer to FIG. 2. FIG. 2 is a diagram illustrating the voltage standing wave ratio (VSWR) of the antenna structure 100 in FIG. 1. The horizontal axis represents frequency (Hz), between 700 MHz and 2.5 GHz, and the vertical axis represents VSWR. As shown in FIG. 2, the frequencies and VSWR of nine signs are marked out. The antenna structure 100 can resonate at the operating frequency band (1710 MHz-2170 MHz) of the first resonance mode through the first radiation object 121, i.e. the signs 4, 5, 6, and 7 marked in FIG. 2. Furthermore, the antenna structure 100 can resonate at the operating frequency band (880 MHz-960 MHz and 824-894 MHz) of the second resonance mode through the first radiation arm 123, the second radiation arm 124, and the third radiation arm 125 of the second radiation object 122, i.e. the signs 1, 2, and 3 marked in FIG. 2. In addition, the antenna structure 100 can resonate at the operating frequency band (1570-1580 MHz) of the third resonance mode through the first radiation arm 123, i.e. the sign 9 marked in FIG. 2. As can be seen from FIG. 2, in frequencies adjacent to 1710-2710 MHz, 800 MHz, 900 MHz, or 1570 MHz, the VSWR all fall below 3, which can satisfy the demands of the 3G wireless communication system.

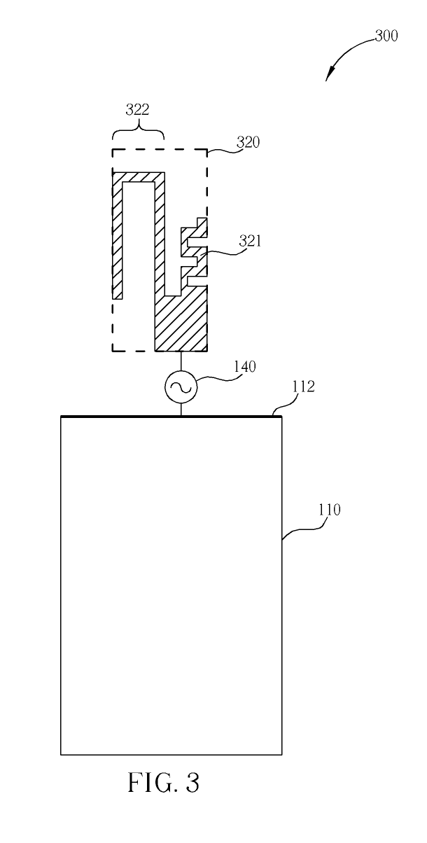

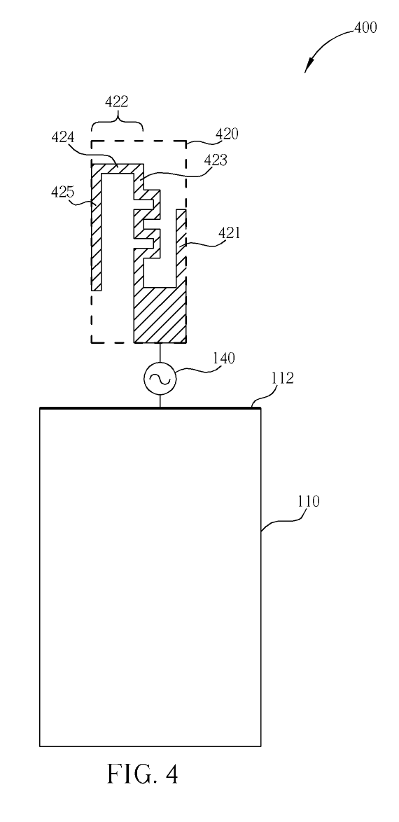

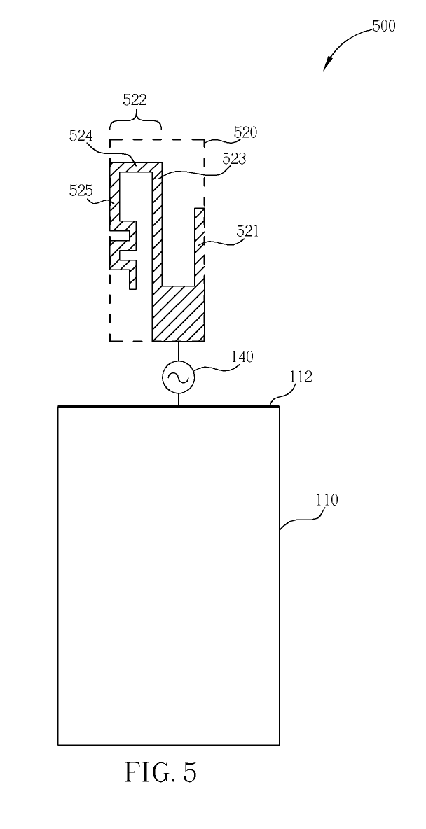

The antenna structure 100 shown in FIG. 1 is merely an embodiment of the present invention, and, as is well known by persons of ordinary skill in the art, suitable variations can be applied to the antenna structure 100. For example, several bends can be formed individually on the first radiation object 121 and the second radiation object 122. Please refer to FIG. 3-FIG. 5. FIG. 3, FIG. 4, and FIG. 5 are diagrams of an antenna structure according to other embodiments of the present invention. In FIG. 3, the architecture of an antenna structure 300 is similar to the architecture of the antenna structure 100 in FIG. 1, which is a changed form of the antenna structure 100. Please note that the difference between them is that a radiation element 320 of the antenna structure 300 includes a first radiation object 321 and a second radiation object 322, wherein the first radiation object 321 includes at least one bend. In FIG. 4, an antenna structure 400 is a changed form of the antenna structure 100. The difference between them is that a radiation element 420 of the antenna structure 400 includes a first radiation object 421 and a second radiation object 422, and the second radiation object 422 includes a first radiation arm 423, a second radiation arm 424, and a third radiation arm 425, wherein the first radiation arm 423 includes at least one bend. In FIG. 5, an antenna structure 500 is a changed form of the antenna structure 100. The difference between them is that a radiation element 520 of the antenna structure 500 includes a first radiation object 521 and a second radiation object 522, and the second radiation object 522 includes a first radiation arm 523, a second radiation arm 524, and a third radiation arm 525, wherein the third radiation arm 525 includes at least one bend.

Those skilled in the art should appreciate that various modifications of the antenna structures in FIG. 3-FIG. 5 may be made without departing from the spirit of the present invention. For example, the antenna structures in FIG. 3-FIG. 5 can be arranged or combined randomly into a new varied embodiment. The abovementioned embodiments are merely used for illustrating practicable designs of the present invention, and should not be limitations of the present invention. Furthermore, the number of the bends is not limited.

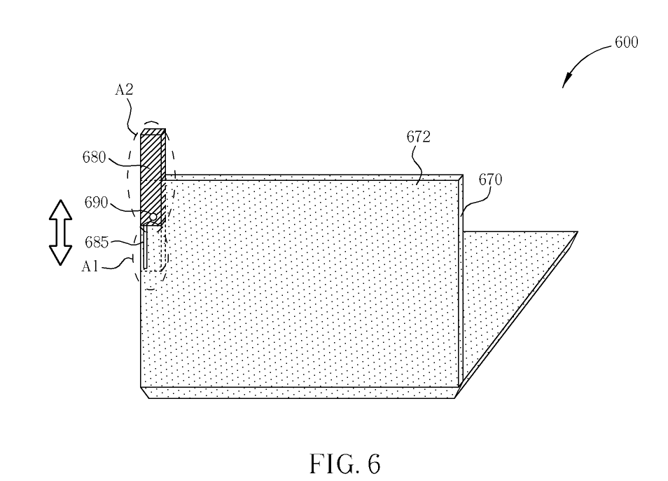

Please refer to FIG. 6. FIG. 6 is a diagram of a wireless communication apparatus 600 according to an embodiment of the present invention. In this embodiment, the wireless communication apparatus 600 is a notebook computer, but is not a limitation of the present invention and can be a wireless communication apparatus of other types. The wireless communication apparatus 600 includes a housing 670, an extendable antenna 680, a sliding mechanism 685 (such as a sliding-track disposed below the extendable antenna 680), and a contact switch 690. The housing 670 is constructed of a conductive material, such as an Al—Mg alloy, but is not limited to this only. When the extendable antenna 680 is in a closed position A1, the extendable antenna 680 is located inside the housing 670. When the extendable antenna 680 is in an operated position A2, the extendable antenna 680 is exposed to the housing 670, which is shown in FIG. 6. The extendable antenna 680 can be implemented by the antenna structure 100 shown in FIG. 1. The architecture and operations of the antenna structure 100 are already described above (please refer to FIG. 1) and are therefore not detailed herein. Of course, the extendable antenna 680 can also be implemented by changed forms of the antenna structure 100, such as the antenna structures 300, 400, 500, or any combinations of them in FIG. 3-FIG. 5.

Please refer to FIG. 6 together with FIG. 1. The sliding mechanism 685 is used for carrying the extendable antenna 680 and guiding the extendable antenna 680 sliding to the closed position A1 or the operated position A2. The contact switch 690 is used for contacting the housing 670 to electrically connect the extendable antenna 680 to the housing 670 when the extendable antenna 680 is in the operated position A2. Please note that when the extendable antenna 680 is in the operated position A2, a first plane 672 of the housing 670 is viewed as a grounding plane of the extendable antenna 680. Assume that the extendable antenna 680 is implemented by the antenna structure 100 shown in FIG. 1. Thus, the first radiation object 121 and the first plane 672 of the housing 670 form a monopole antenna, and the second radiation object 122 and the first plane 672 of the housing 672 form another monopole antenna. Please note that, any components that can make the extendable antenna 680 in the operated position A2 contact the housing 670 can be used as the contact switch 690. Besides, the installed position of the contact switch 690 shown in FIG. 6 is merely an exemplary embodiment for illustration and should not be a limitation of the present invention.

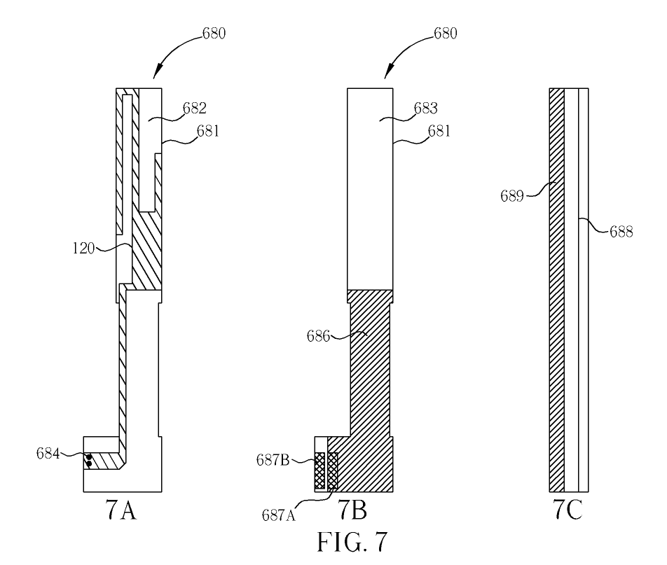

Please note that, again, the abovementioned extendable antenna 680 doesn't necessarily mean that the antenna structure itself is extendable, or rather by using a carrier board to carry the extendable antenna 680 together with the sliding mechanism (such as the sliding-track below the extendable antenna 680) to expand and contract the extendable antenna 680 within the housing 670. When the extendable antenna 680 is in the operated position A2, it can electrically connect to the first plane 672 of the housing 670 through the contact switch 690. Please refer to FIG. 7. FIG. 7 is a diagram showing an exemplary embodiment of the extendable antenna 680 and the sliding mechanism 685 in FIG. 6. 7A in FIG. 7 is a top-view diagram of the extendable antenna 680. The radiation element 120 shown in FIG. 1 is disposed on a top plane 682 of a substrate 681 by layout, and changes layers to a bottom plane 683 of the substrate 681 through via 684. 7B in FIG. 7 is a bottom-view diagram of the extendable antenna 680. A grounding plane 686 is disposed in the bottom plane 683 of the substrate 681, and the grounding plane 686 is electrically connected to a first connector 687A. The via 684 is electrically connected to a second connector 687B of the bottom plane 683. 7C in FIG. 7 shows the sliding mechanism 685 in FIG. 6, which cooperates with the extendable antenna 680 shown in 7A and 7B. A micro-strip line 688 is electrically connected to the first connector 687A (i.e., electrically connected to the grounding plane 686), and a grounding micro-strip line 689 is electrically connected to the second connector 687B (i.e., electrically connected to the radiation element 120). The extendable antenna 680 can expand and contract in the housing 670 through the sliding mechanism 685.

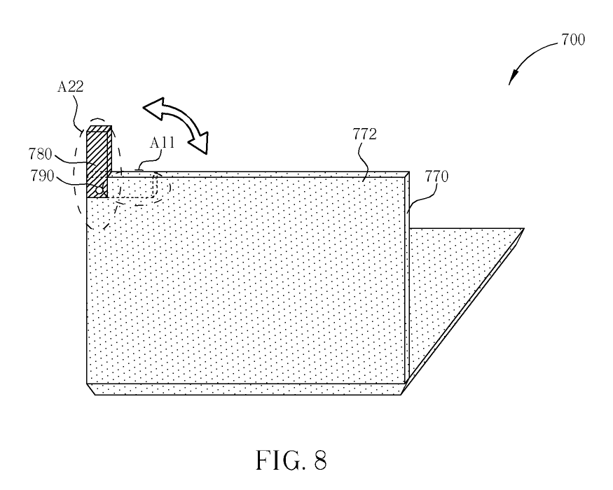

Please refer to FIG. 8. FIG. 8 is a diagram of a wireless communication apparatus 700 according to another embodiment of the present invention. The wireless communication apparatus 700 is a notebook computer, but is not a limitation of the present invention and can be a wireless communication apparatus of other types. The wireless communication apparatus 700 includes a housing 770, an extendable antenna 780, and a rotating mechanism 790. When the extendable antenna 780 is in a closed position A11, the extendable antenna 780 is located inside the housing 770. When the extendable antenna 780 is in an operated position A22, the extendable antenna 780 is exposed to the housing 770, which is shown in FIG. 8. The extendable antenna 780 can be implemented by the antenna structure 100 shown in FIG. 1. The architecture and operations of the antenna structure 100 are already described above (in FIG. 1) and are therefore not detailed herein. Of course, the extendable antenna 780 can also be implemented by changed forms of the antenna structure 100, such as the antenna structures 300, 400, 500, or any combinations of them in FIG. 3-FIG. 5.

Please keep referring to FIG. 8 together with FIG. 1. The rotating mechanism 790 is coupled to the extendable antenna 780 in a rotatable manner for guiding the extendable antenna 780 rotating to the closed position A11 or the operated position A22. The rotating mechanism 790 contacts the housing 770 to electrically connect the extendable antenna 780 to the housing 770 when the extendable antenna 780 is in the operated position A22. That is, the rotating mechanism 790 in this embodiment can be used as not only a rotating axle to rotate the extendable antenna 780 freely but also as a conduction path between the housing 770 and the extendable antenna 780. Please note that, when the extendable antenna 780 is in the operated position A22, a first plane 772 of the housing 770 is viewed as the grounding plane of the extendable antenna 780. Assume that the extendable antenna 780 is implemented by the antenna structure 100 shown in FIG. 1, the first radiation object 121 and the first plane 772 of the housing 770 form a monopole antenna, and the second radiation object 122 and the first plane 772 of the housing 770 form another monopole antenna.

Please note again that the abovementioned extendable antenna 780 doesn't mean that the antenna structure itself is extendable, or rather by using the rotating mechanism 790 to expand and contract the extendable antenna 780 in the housing 770 (to expose to the housing 770 or fit into the housing 770 through the rotating mechanism 790). When the extendable antenna 780 is in the operated position A22, it is electrically connected to the first plane 772 of the housing 770 through the rotating mechanism 790.

Please note again that the abovementioned sliding mechanism 685 and rotating mechanism 790 are used merely for illustrating how to move/rotate the extendable antennas 680 and 780 to the closed positions A1 and A11 or the operated positions A2 and A22, and should not be limitations of the present invention. Those skilled in the art should appreciate that the sliding mechanism 685 and the rotating mechanism 790 can be implemented by other components that can be used for controlling the extendable antenna to move to the closed position or the operated position without departing from the spirit of the present invention. Furthermore, the closed positions A1 and A11 or the operated positions A2 and A22 are not limited to the positions marked in FIG. 6 and FIG. 8. Those skilled in the art should appreciate that appropriate modifications may be made, which should also belong to the scope of the present invention.

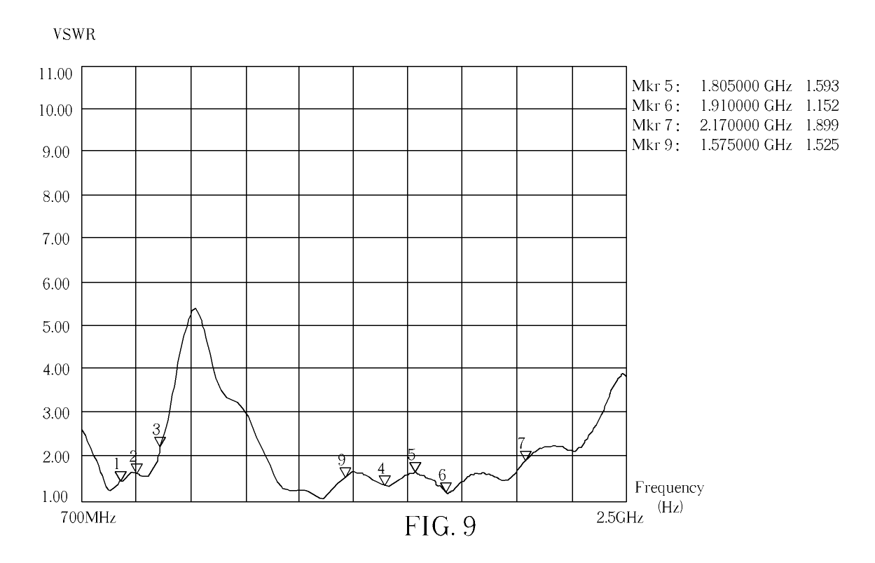

Please refer to FIG. 9. FIG. 9 is a diagram illustrating the VSWR of the extendable antenna 680 in FIG. 6. The horizontal axis represents frequency (Hz), which distributes between 700 MHz and 2.5 GHz, and the vertical axis represents VSWR. As shown in FIG. 9, the frequencies and VSWR of nine signs are marked out. The extendable antenna 680 can resonate at the operating frequency band (1710 MHz-2170 MHz) of the first resonance mode, i.e. the signs 4, 5, 6, and 7 marked in FIG. 9. Furthermore, the extendable antenna 680 can resonate at the operating frequency band (880 MHz-960 MHz and 824-894 MHz) of the second resonance mode, i.e. the signs 1, 2, and 3 marked in FIG. 9. In addition, the extendable antenna 680 can resonate at the operating frequency band (1570-1580 MHz) of the third resonance mode, i.e. the sign 9 marked in FIG. 9. As can be known in FIG. 9, for all frequencies adjacent to 1710 MHz-2710 MHz, 800 MHz, 900 MHz, or 1570 MHz, the VSWR all fall below 3, which satisfies demands of the 3G wireless communication system.

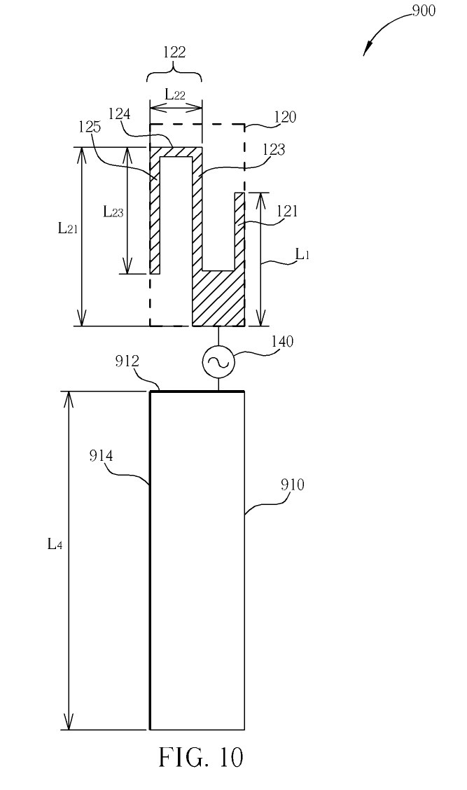

Please refer to FIG. 10 and compare with FIG. 1. FIG. 10 is a diagram of an antenna structure 900 according to another embodiment of the present invention. As shown in FIG. 10, the antenna structure 900 includes a conductive film 910, a radiation element 120, and a feeding point 140. The antenna structure 900 is similar to the antenna structure 100 in FIG. 1, and the difference between them is that the area of the conductive film 910 of the antenna structure 900 is smaller than a predetermined area. As can be seen from FIG. 1 and FIG. 10, the area of the conductive film 910 is much smaller than that of the conductive film 110. As for the first radiation object 121, the conductive film is viewed as a grounding plane. The first radiation object 121 and the conductive film 910 form a monopole antenna. As for the second radiation object 122, however, the conductive film is viewed as a radiator. At this time, the second radiation object 122 and the conductive film 910 form a dipole-like antenna.

Please note that the conductive film 910 includes a first side 912 and a second side 914, wherein the length L₄ of the second side 914 is a sum of the lengths (i.e. L₄=L₂₁+L₂₂+L₂₃) of the first radiation arm 123, the second radiation arm 124, and the third radiation arm 125. The length of the first side 912 is approximately the distance between the first radiation object 121 and the third radiation arm 125. The predetermined area of the conductive film 910 is determined according to whether the first radiation object 121 and the second radiation object 122 respectively form a monopole antenna and a dipole-like antenna with the conductive film 910. In one embodiment, the conductive film 910 is constructed of metal material, such as Al—Mg alloy, but is not limited to this only.

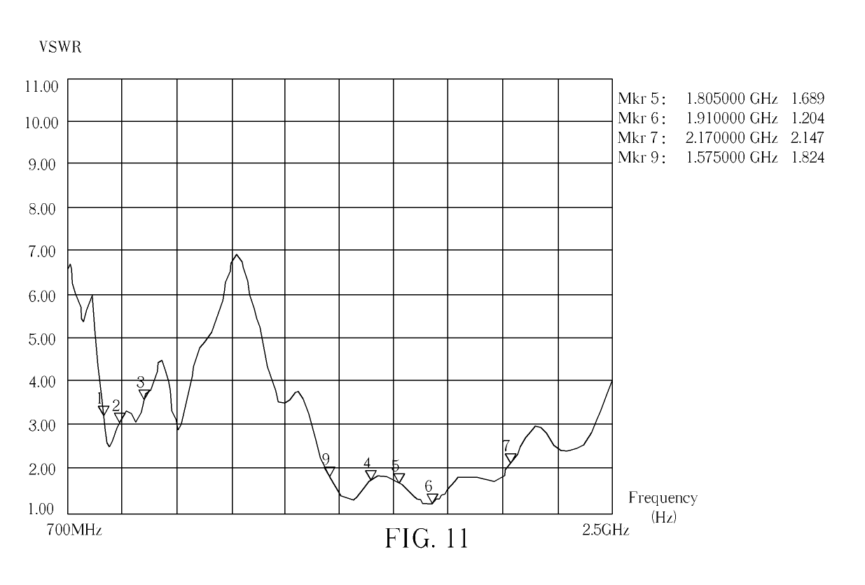

Please refer to FIG. 11. FIG. 11 is a diagram illustrating the VSWR of the antenna structure 900 in FIG. 10. The horizontal axis represents frequency (in Hz) between 700 MHz and 2.5 GHz, and the vertical axis represents VSWR. As shown in FIG. 11, the frequencies and VSWR of nine signs are marked out. The antenna structure 900 can resonate at the operating frequency band (1710 MHz-2170 MHz) of the first resonance mode through the first radiation object 121, i.e. the signs 4, 5, 6, and 7 marked in FIG. 11. Furthermore, the antenna structure 900 can resonate at the operating frequency band (880 MHz-960 MHz and 824-894 MHz) of the second resonance mode through the first radiation arm 123, the second radiation arm 124, and the third radiation arm 125 of the second radiation object 122 together with the conductive film 910, i.e. the signs 1, 2, and 3, as marked in FIG. 11. In addition, the antenna structure 900 can resonate at the operating frequency band (1570-1580 MHz) of the third resonance mode through the first radiation arm 123, i.e. the sign 9 marked in FIG. 11. As shown in FIG. 11, although it doesn't reach a perfect match in frequencies adjacent to 880-960 MHz and 824-894 MHz, a match status of a dipole-like antenna formed by the second radiation object 122 and the conductive film 910 can be adjusted through adjusting the length L₄ of the second side 914 of the conductive film 910. For the frequencies adjacent to 1710-2710 MHz or 1570 MHz, the VSWR all fall below 3, which satisfies GPS and UMTS requirements.

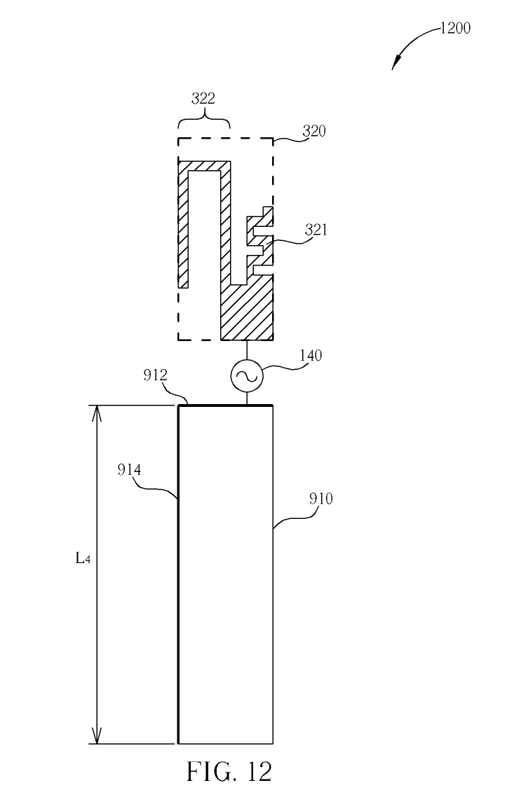

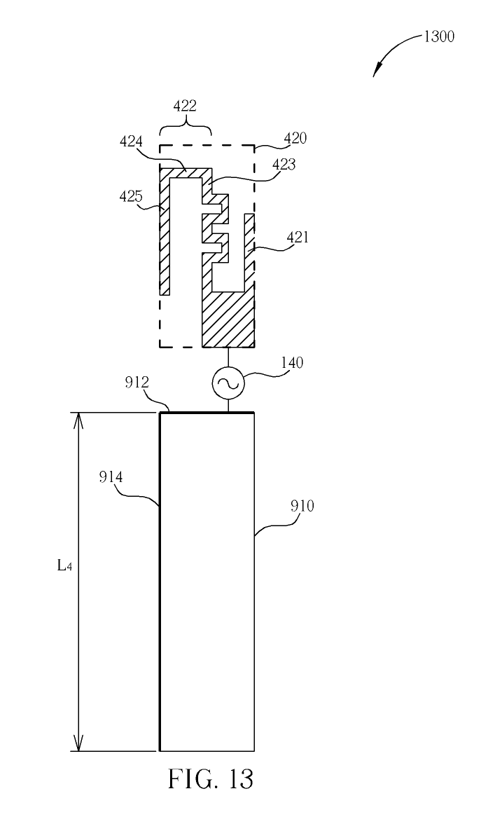

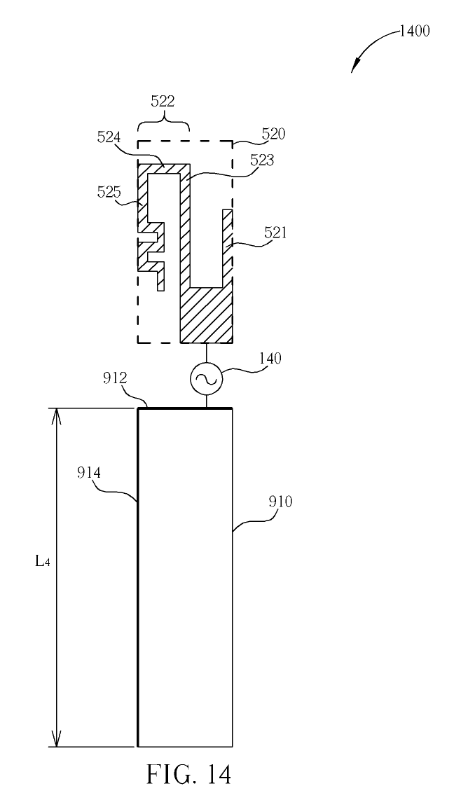

The antenna structure 900 shown in FIG. 10 is merely an embodiment of the present invention, and as is well known by persons of ordinary skill in the art, suitable variations can be applied to the antenna structure 900. For example, several bends can be formed individually on the first radiation object 121 and the second radiation object 122. Please refer to FIG. 12-FIG. 14. FIG. 12, FIG. 13, and FIG. 14 are diagrams of antenna structures according to other embodiments of the present invention. In FIG. 12, the architecture of an antenna structure 1200 is similar to the architecture of the antenna structure 900 in FIG. 10, which is a changed form of the antenna structure 900. Please note that the difference between them is that the first radiation object 321 of the antenna structure 1200 includes at least one bend. In FIG. 13, an antenna structure 1300 is a changed form of the antenna structure 900. The difference between them is that the first radiation arm 423 of the second radiation object 422 of the antenna structure 1300 includes at least one bend. In FIG. 14, an antenna structure 1400 is a changed form of the antenna structure 900. The difference between them is that the third radiation arm 525 of the second radiation object 522 of the antenna structure 1400 includes at least one bend.

Those skilled in the art should appreciate that various modifications of the antenna structures in FIG. 12-FIG. 14 may be made without departing from the spirit of the present invention. For example, the antenna structures in FIG. 12-FIG. 14 can be arranged or combined randomly into a new varied embodiment. The abovementioned embodiments are presented merely for illustrating practicable designs of the present invention, and should not be limitations of the present invention. Furthermore, the number of the bends is not limited.

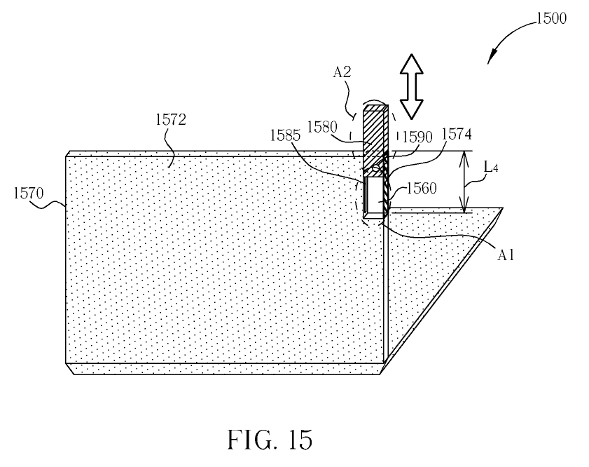

Please refer to FIG. 15. FIG. 15 is a diagram of a wireless communication apparatus 1500 according to an embodiment of the present invention. In this embodiment, the wireless communication apparatus 1500 is a notebook computer, but is not a limitation of the present invention and can be a wireless communication apparatus of other types. The wireless communication apparatus 1500 includes a housing 1570, an extendable antenna 1580, a sliding mechanism 1585 (such as a sliding-track disposed below the extendable antenna 1580), a contact switch 1590, and an opening 1560. The housing 1570 is constructed of a conductive material, such as an Al-Mg alloy, but is not limited to this only. The housing 1570 includes a first plane 1572 and a second plane 1574, wherein the second plane 1574 is approximately perpendicular to the first plane 1572 and the length L₄ of the second plane 1574 is designed as L₄=L₂₁+L₂₂+L₂₃ (shown in FIG. 10). The opening 1560 is located on the housing 1570 and is disposed between the first plane 1572 and the second plane 1574 such that the second plane 1574 does not electrically connect to the first plane 1572. When the extendable antenna 1580 is in the closed position A1, the extendable antenna 1580 is stored inside a space of the housing 1570 corresponding to the opening 1560. When the extendable antenna 1580 is in the operated position A2, the extendable antenna 1580 is exposed to the housing 1570, which is shown in FIG. 15. The extendable antenna 1580 can be implemented by the antenna structure 900 shown in FIG. 10. The architecture and operations of the antenna structure 900 are already described above (please refer to FIG. 9) and are therefore not detailed herein. Of course, the extendable antenna 1580 can also be implemented by changed forms of the antenna structure 900, such as the antenna structures 1200, 1300, 1400, or any combinations of them in FIG. 12-FIG. 14.

Please refer to FIG. 15 together with FIG. 10. The sliding mechanism 1585 is used for carrying the extendable antenna 1580 and guiding the extendable antenna 1580 sliding to the closed position A1 or the operated position A2. The contact switch 1590 is used for contacting the housing 1570 to electrically connect the extendable antenna 1580 to the housing 1570 when the extendable antenna 1580 is in the operated position A2. Please note that when the extendable antenna 1580 is in the operated position A2, the first plane 1572 of the housing 1570 is viewed as a grounding plane. Assume that the extendable antenna 1580 is implemented by the antenna structure 900 shown in FIG. 10, the first radiation object 121 is close to the first plane 1572 of the housing 1570 and the second radiation object 122 is close to the second plane 1574 of the housing 1570. That is, the top view of the antenna structure 900 in FIG. 10 is the bottom view of the extendable antenna 1580 in FIG. 15. Therefore, the first radiation object 121 and the first plane 1572 of the housing 1570 form a monopole antenna. Similarly, when the extendable antenna 1580 is in the operated position A2, because the area of the second plane 1574 of the housing 1570 is smaller than the predetermined area and the length L₄ is designed as L₄=L₂₁+L₂₂+L₂₃, the second plane 1574 of the housing 1570 is viewed as a radiator. Assume that the extendable antenna 1580 is implemented by the antenna structure 900 in FIG. 10, the second radiation object 122 and the second plane 1574 of the housing 1570 form a dipole-like antenna.

The purpose of the abovementioned opening 1560 is used for making the second plane 1574 not electrically connect to the first plane 1572. In fact, if only the opening 1560 is disposed between the first plane 1572 and the second plane 1574, the second plane 1574 can still electrically connect to the first plane 1572 through the bottom extended parts. However, when the extendable antenna 1580 in the operated position A2, the width of the second plane 1574 is much smaller (the area of the second plane 1574 is smaller than the area of the first plane 1572) and maintains for a length of L₄. Thus, it can be viewed as a dipole-like antenna, and won't have any impact even if the second plane 1574 electrically connects to the plane 1572 through the bottom extended parts. In other words, the purpose of the opening 1560 is used for ensuring that the second plane 1574 won't immediately electrically connect to the first plane 1572. Or, a small chink (or a small gap) can be added to the second plane 1574 at the position near the length L₄ to ensure that the second plane 1574 is completely electrically disconnected from the first plane 1572.

Please note again that the abovementioned extendable antenna 1580 doesn't mean that the antenna structure itself is extendable, or rather by using a carrier board to carry the extendable antenna 1580 together with the sliding mechanism 1585 (such as the sliding-track below the extendable antenna 1580) to make the extendable antenna 1580 expand and contract in the housing 1570. When the extendable antenna 1580 is in the operated position A2, it can electrically connect to the first plane 1572 of the housing 1570 through the contact switch 1590.

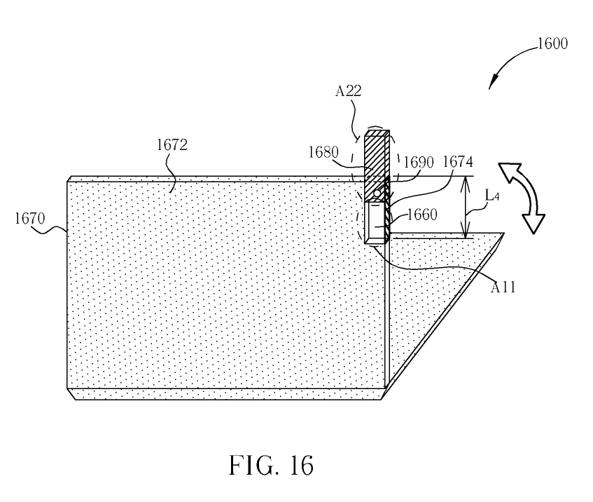

Please refer to FIG. 16. FIG. 16 is a diagram of a wireless communication apparatus 1600 according to another embodiment of the present invention. The wireless communication apparatus 1600 is a notebook computer, but is not a limitation of the present invention and can be a wireless communication apparatus of other types. The wireless communication apparatus 1600 includes a housing 1670, an extendable antenna 1680, a rotating mechanism 1690, and an opening 1660. The housing 1670 is constructed of a conductive material, such as an Al—Mg alloy, but is not limited to this only. The housing 1670 includes a first plane 1672 and a second plane 1674, wherein the second plane 1674 is approximately perpendicular to the first plane 1672 and the length L₄ of the second plane 1674 is designed as L₄=L₂₁+L₂₂+L₂₃ (as in FIG. 10). The opening 1660 is located on the housing 1670 and is disposed between the first plane 1672 and the second plane 1674 to make the second plane 1674 not electrically connect to the first plane 1672. When the extendable antenna 1680 is in the closed position A11 the extendable antenna 1680 is stored inside a space of the housing 1670 corresponding to the opening 1660. When the extendable antenna 1680 is in the operated position A22, the extendable antenna 1680 is exposed to the housing 1670, which is shown in FIG. 16. The extendable antenna 1680 can be implemented by the antenna structure 900 shown in FIG. 10. The architecture and operations of the antenna structure 900 are already described above (please refer to FIG. 10) and are therefore not detailed herein. Of course, the extendable antenna 1680 can also be implemented by changed forms of the antenna structure 900, such as the antenna structures 1200, 1300, 1400, or any combinations of them in FIG. 12-FIG. 14.

Please refer to FIG. 16 together with FIG. 10. The rotating mechanism 1690 is coupled to the extendable antenna 1680 in a rotatable manner for guiding the extendable antenna 1680 rotating to the closed position A11 or the operated position A22. The rotating mechanism 1690 contacts the housing 1670 to electrically connect the extendable antenna 1680 to the housing 1670 when the extendable antenna 1680 is in the operated position A22. Please note that when the extendable antenna 1680 in the operated position A22, the first plane 1672 of the housing 1670 is viewed as a grounding plane. Assume that the extendable antenna 1680 is implemented by the antenna structure 900 shown in FIG. 10, the first radiation object 121 is close to the first plane 1672 of the housing 1670 and the second radiation object 122 is close to the second plane 1674 of the housing 1670 when the extendable antenna 1680 is in the operated position A22. That is, the top view of the antenna structure 900 in FIG. 10 is the bottom view of the extendable antenna 1680 in FIG. 16. Therefore, the first radiation object 121 and the first plane 1672 of the housing 1670 form a monopole antenna. Similarly, when the extendable antenna 1680 is in the operated position A22, because the area of the second plane 1674 of the housing 1670 is smaller than the predetermined area and the length L₄ is designed as L₄=L₂₁+L₂₂+L₂₃, the second plane 1674 of the housing 1670 is viewed as a radiator. Assume that the extendable antenna 1680 is implemented by the antenna structure 900 in FIG. 10, the second radiation object 122 and the second plane 1674 of the housing 1670 form a dipole-like antenna.

Please note that again the abovementioned extendable antenna 1680 doesn't mean that the antenna structure itself is extendable, or rather by using the rotating mechanism 1690 to expand and contract the extendable antenna 1680 out of and into the housing 1670 (to expose to the housing 1670 or fit into the housing 1670 through the rotating mechanism 1690). When the extendable antenna 1680 is in the operated position A22, it is electrically connected to the first plane 1672 of the housing 1670 through the rotating mechanism 1690.

Please note that again, the abovementioned sliding mechanism 1585 and rotating mechanism 1690 are merely used for illustrating how to move/rotate the extendable antennas 1580 and 1680 to the closed positions A1 and A11 or the operated positions A2 and A22, and should not be limitations of the present invention. Those skilled in the art should appreciate that the sliding mechanism 1585 and the rotating mechanism 1690 can be implemented by other components that can be used for controlling the extendable antenna to move to the closed position or the operated position without departing from the spirit of the present invention. Furthermore, the closed positions A1 and A11 or the operated positions A2 and A22 are not limited to the positions marked in FIG. 15 and FIG. 16. Those skilled in the art should appreciate that appropriate modifications may be made, which should also belong to the scope of the present invention. Please note that again, in the embodiments above, it makes the second plane not electrically connect to the first plane through adding an opening between the first plane and the second plane, but this is merely an implementation and can be replaced with other manners. For example, a non-conductive material is filled up between the first plane and the second plane to make the second plane not electrically connect to the first plane, but this also should not be a limitation of the present invention.

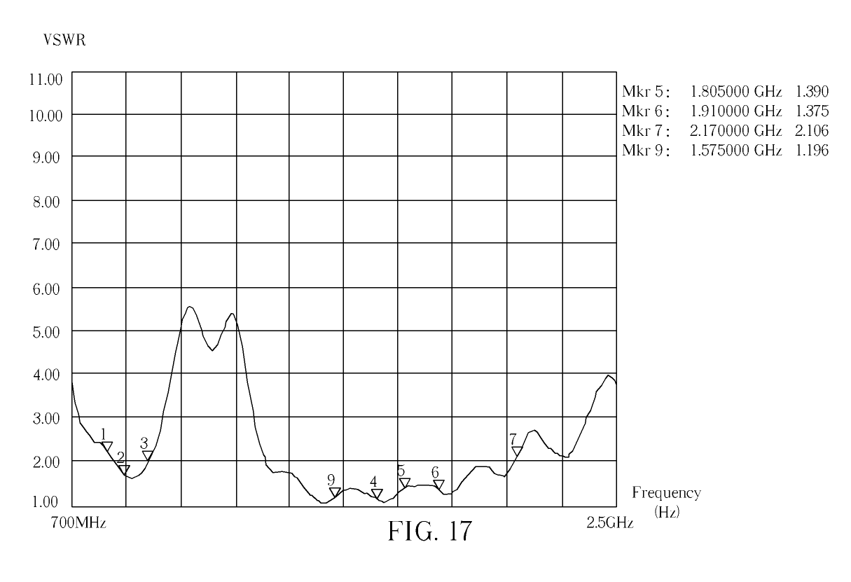

Please refer to FIG. 17. FIG. 17 is a diagram illustrating the VSWR of the extendable antenna 1580 in FIG. 15. The horizontal axis represents frequency (Hz), between 700 MHz and 2.5 GHz, and the vertical axis represents VSWR. As shown in FIG. 17, the frequencies and VSWR of nine signs are marked out. The extendable antenna 1580 together with the first plane 1572 of the housing 1570 can resonate at the operating frequency band (1710 MHz-2170 MHz) of the first resonance mode, i.e. the signs 4, 5, 6, and 7 marked in FIG. 16. Furthermore, the extendable antenna 1580 together with the second plane 1574 of the housing 1570 can resonate at the operating frequency band (880 MHz-960 MHz and 824-894 MHz) of the second resonance mode, i.e. the signs 1, 2, and 3 marked in FIG. 17. In addition, the extendable antenna 1580 together with the first plane 1572 of the housing 1570 can resonate at the operating frequency band (1570-1580 MHz) of the third resonance mode, i.e. the sign 9 marked in FIG. 17. As can be seen in FIG. 17, for frequencies adjacent to 1710-2710 MHz, 800 MHz, 900 MHz, or 1570 MHz, the VSWR all fall below 3, which can satisfy demands of the wireless communication system in 3G.

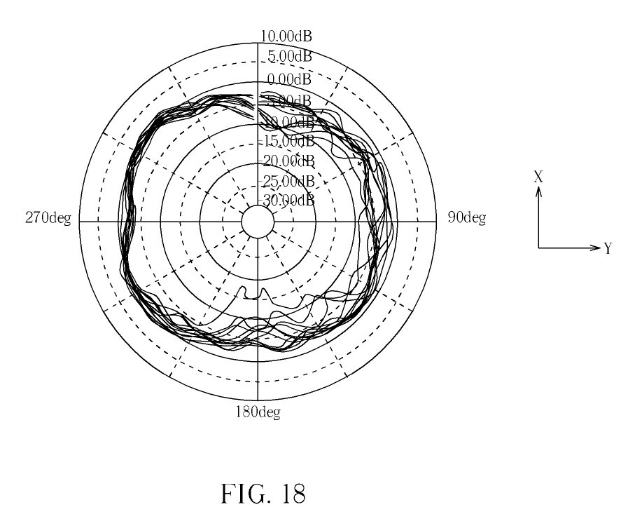

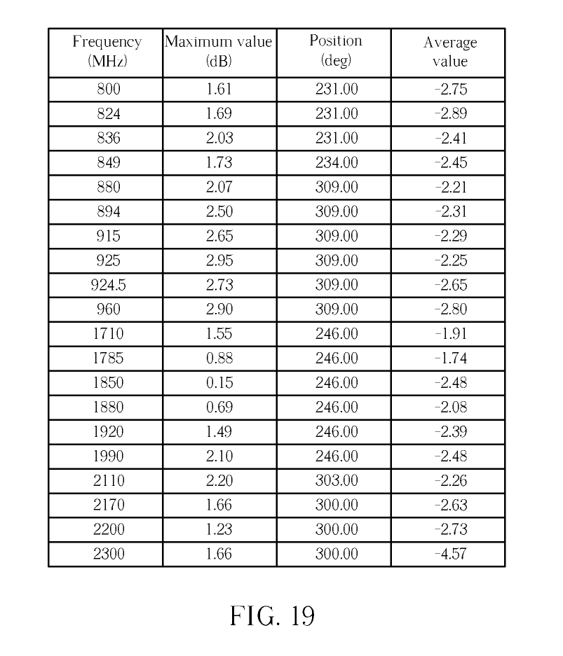

Please refer to FIG. 18 and FIG. 19. FIG. 18 is a diagram of a radiation pattern of the wireless communication apparatus 1500 in FIG. 15. FIG. 19 is a diagram of an antenna gain table of the wireless communication apparatus 1500 in FIG. 15. As shown in FIG. 18, which shows measurement results of the extendable antenna 1580 in XY plane. As can be seen, the radiation pattern of the extendable antenna 1580 is similar to a circle and is an omni-directional antenna. FIG. 19 is a diagram marking out positions and values of the maximum and average values of the antenna gain in each frequency band in FIG. 18. As can be seen, the average gains of the extendable antenna 1580 all fall above −2.98 dB in the frequency bands of 3G and GPS.

The abovementioned embodiments are presented merely for describing the present invention, and in no way should be considered to be limitations of the scope of the present invention. The abovementioned antenna structures 100 and 900 can include a plurality of changed forms. For example, the antenna structures 300, 400, 500, 1200, 1300, and 1400 are formed through adding the number of bends to the first radiation object 121 and the second radiation object 122. However, the resonance modes generated by the antenna structure 100 are merely examples and are not limited to those only, or other resonance modes in other wireless communication standards are also suitable by proper designs. In addition, the lengths of L₁, L₂₁, L₂₂, and L₂₃ are not fixed and can be designed according to user demands. In one embodiment, the conductive films 110 and 910 and the housings 670, 770, 1570, and 1670 are constructed by metal material, such as an Al—Mg alloy, but is not limited to this only. The area and the length of the conductive films 110 and 910 can be adjusted according to user demands to be suitable for different antenna structures (such as monopole antennas and dipole-like antennas). The wireless communication apparatuses 600, 700, 1500, and 1600 can be a notebook computer, but is not a limitation of the present invention and can be a wireless communication apparatus of other types. Please note that, the abovementioned sliding mechanisms 685 and 1585 and rotating mechanisms 790 and 1690 are merely used for illustrating how to move/rotate the extendable antennas to the closed positions A1 and A11 or the operated positions A2 and A22, and should not be limitations of the present invention. Those skilled in the art should appreciate that the sliding mechanisms 685 and 1585 and the rotating mechanisms 790 and 1690 can be implemented by other components that can be used for controlling the extendable antenna to move to the closed position or the operated position without departing from the spirit of the present invention. Furthermore, the closed positions A1 and A11 or the operated positions A2 and A22 are not limited to the positions marked in the embodiments above. Those skilled in the art should appreciate that appropriate modifications may be made, which should also belong to the scope of the present invention. Please note again that, in the embodiments above, the second plane is not electrically connected to the first plane by adding an opening between the first plane and the second plane, but this is merely an implement and can be replaced by other manners. For example, a non-conductive material can be inserted between the first plane and the second plane to make the second plane not electrically connect to the first plane, which should also belong to the scope of the present invention.

From the above descriptions, the present invention provides the antenna structures 100 and 900 and related wireless communication apparatuses 600, 700, 1500, and 1600. Through the sliding mechanisms 685 and 1585 or the rotating mechanisms 790 and 1690, the extendable antenna can be pulled out when it is used and can be stored into the housing when it is not used, which can achieve not only the aesthetic effect but also the effect for reducing volume. In addition, through combining the extendable antenna with the housing constructed by conductive material, a monopole antenna or a dipole-like antenna can be formed to be suitable to various applications. Furthermore, as is known from the VSWR, radiation pattern, and the antenna gain table of the antenna structure, the antenna structure disclosed in the present invention has advantages such as providing a omni-directional radiation pattern, improving antenna efficiency, reducing antenna sizes, and covering frequency bands in existing wireless communication systems. Therefore, the antenna structure disclosed in the present invention is suitable to be applied to notebook computers or wireless communication apparatuses of other types.

Those skilled in the art will readily observe that numerous modifications and alterations of the device and method may be made while retaining the teachings of the invention.

What is claimed is:

1. An antenna structure comprising:
a conductive film;
a radiation element comprising:
a first radiation object; and
a second radiation object, having a first radiation arm, a second radiation arm, and a third radiation arm, the first radiation arm being coupled to the first radiation object, and the second radiation arm being extended from the first radiation arm to be coupled to the third radiation arm, wherein there is a first angle included between the first radiation arm and the second radiation arm, and there is a second angle included between the second radiation arm and the third radiation arm; and
a feeding point, coupled between the conductive film and the radiation element.

2. The antenna structure of claim 1, wherein the first angle and the second angle are right angles.

3. The antenna structure of claim 1, wherein an area of the conductive film is greater than a predetermined area, the first radiation object and the conductive film form a monopole antenna, and the second radiation object and the conductive film form another monopole antenna.

4. The antenna structure of claim 1, wherein an area of the conductive film is smaller than a predetermined area, the first radiation object and the conductive film form a monopole antenna, and the second radiation object and the conductive film form a dipole-like antenna.

5. The antenna structure of claim 4, wherein the conductive film comprises a side, a length of the side being approximately a sum of a length of the first radiation arm, a length of the second radiation arm, and a length of the third radiation arm.

6. The antenna structure of claim 1, wherein the conductive film comprises a first side and a second side, a length of the first side being approximately a distance between the first radiation object and the third radiation arm, and a length of the second side being approximately a sum of a length of the first radiation arm, a length of the second radiation arm, and a length of the third radiation arm.

7. The antenna structure of claim 1, wherein the radiation element presents an S-type.

8. The antenna structure of claim 1, wherein a length of the first radiation object is approximately one-fourth of a wavelength of a first resonance mode generated by the antenna structure, and a sum of a length of the first radiation arm, a length of the second radiation arm, and a length of the third radiation arm is approximately one-fourth of a wavelength of a second resonance mode generated by the antenna structure.

9. A wireless communication apparatus comprising:
a housing, formed with a conductive material; and
an extendable antenna, the extendable antenna being located inside the housing when the extendable antenna is in a closed position, and the extendable antenna being exposed to the housing when the extendable antenna is in an operated position, the extendable antenna comprising:
a radiation element comprising:
a first radiation object; and
a second radiation object, having a first radiation arm, a second radiation arm, and a third radiation arm, the first radiation arm being coupled to the first radiation object, and the second radiation arm being extended from the first radiation arm to be coupled to the third radiation arm, wherein there is a first angle included between the first radiation arm and the second radiation arm, and there is a second angle included between the second radiation arm and the third radiation arm; and
a feeding point.

10. The wireless communication apparatus of claim 9, wherein the first angle and the second angle are right angles.

11. The wireless communication apparatus of claim 9, wherein when the extendable antenna is in the operated position, the first radiation object is approximately perpendicular to a side of a first plane of the housing.

12. The wireless communication apparatus of claim 9 further comprising:
a sliding mechanism, for carrying the extendable antenna and guiding the extendable antenna sliding to the closed position or the operated position; and
a contact switch, for contacting the housing to electrically connect the extendable antenna to the housing when the extendable antenna is in the operated position.

13. The wireless communication apparatus of claim 9 further comprising:
a rotating mechanism, coupled to the extendable antenna in a rotatable manner, for guiding the extendable antenna rotating to the closed position or the operated position, wherein the rotating mechanism contacts the housing to electrically connect the extendable antenna to the housing when the extendable antenna is in the operated position.

14. The wireless communication apparatus of claim 9, wherein when the extendable antenna is in the operated position, the first radiation object and a first plane of the housing form a monopole antenna, and the second radiation object and the first plane form another monopole antenna.

15. The wireless communication apparatus of claim 9, wherein a length of the first radiation object is approximately one-fourth of a wavelength of a first resonance mode generated by the extendable antenna, and a sum of a length of the first radiation arm, a length of the second radiation arm, and a length of the third radiation arm is approximately one-fourth of a wavelength of a second resonance mode generated by the extendable antenna.

16. The wireless communication apparatus of claim 9, wherein the housing comprises a first plane and a second plane, when the extendable antenna is in the operated position, the first radiation object and the first plane form a monopole antenna, and the second radiation object and the second plane form an dipole-like antenna.

17. The wireless communication apparatus of claim 16, wherein the housing comprises an opening disposed between the first plane and the second plane, and the extendable antenna is stored inside a space of the housing corresponding to the opening when the extendable antenna is in the closed position.

18. The wireless communication apparatus of claim 16, wherein a non-conductive material is filled between the first plane and the second plane to make the second plane not electrically connect to the first plane.

19. A wireless communication apparatus comprising:
a housing, formed with a conductive material; and
an extendable antenna, the extendable antenna being exposed to the housing and coupled to the housing when the extendable antenna is in an operated position, the extendable antenna comprising:
a radiation element comprising:
a first radiation object; and
a second radiation object, having a first radiation arm, a second radiation arm, and a third radiation arm, the first radiation arm being coupled to the first radiation object, and the second radiation arm being extended from the first radiation arm to be coupled to the third radiation arm; and
a feeding point.

20. The wireless communication apparatus of claim 19, wherein the housing comprises a first plane and a second plane, and an opening is disposed between the first plane and the second plane, when the extendable antenna is in the operated position, the first radiation object and the first plane form a monopole antenna, and the second radiation object and the second plane form a dipole-like antenna.

21. The wireless communication apparatus of claim 19, wherein the housing comprises an opening disposed between a first plane and a second plane of the housing, and the extendable antenna is stored inside a space of the housing corresponding to the opening when the extendable antenna is in a closed position.

22. The wireless communication apparatus of claim 19 further comprising:
a sliding mechanism, for guiding the extendable antenna sliding to the operated position; and
a contact switch, for contacting the housing to electrically connect the extendable antenna to the housing when the extendable antenna is in the operated position.

23. The wireless communication apparatus of claim 19 further comprising:
a rotating mechanism for guiding the extendable antenna rotating to the operated position; and
a contact switch, for contacting the housing to electrically connect the extendable antenna to the housing when the extendable antenna is in the operated position.
